(19) United States
(12) Patent Application Publication
(10) Pub. No.: US 2025/0020211 A1
(43) Pub. Date: Jan. 16, 2025

(54) Elastomeric Compositions And Seals

(71) Applicant: Freudenberg-NOK General Partnership, Plymouth, MI (US)

(72) Inventors: Ahmad H. NAJAFABADI, Cleveland, GA (US); Darin BATTLES, Dahlonega, GA (US); Christopher BELLER, Cumming, GA (US)

(73) Assignee: Freudenberg-NOK General Partnership, Plymouth, MI (US)

(21) Appl. No.: 18/222,045

(22) Filed: Jul. 14, 2023

(51) Int. Cl. F16J 15/324

(52) U.S. Cl. CPC F16J 15/324

(57) ABSTRACT

Elastomeric compositions, and associated methods of manufacturing seals using such compositions, and methods of use, comprising an elastomeric material and lubricant material. In various embodiments, the elastomeric material comprises an FKM or HNBR elastomer. The lubricant material may be methyl hydroxy stearate, hydroxystearamide, or mixture thereof. Compositions may further comprise a conductive filler, such as conductive carbon black.

### BACKGROUND

The present technology relates to elastomeric compositions and products made using such compositions. In various embodiments, compositions are self-lubricating, and may be adapted for use in sleeves, gaskets and other seals between rotating parts.

A wide variety of elastomeric materials are known in the art. In general, elastomeric materials have a desirable set of physical properties typical of the elastomeric state. They show a high tendency to return to their original size and shape following removal of a deforming force, and they retain physical properties after repeated cycles of stretching, including strain levels up to 1000%. Based on these properties, the materials are generally useful for making shaped articles such as seals and gaskets.

Seals may be generally characterized either as being static (e.g., gaskets) type seals or as dynamic (frequently as flexible or torsion) type seals. Static seals are typically disposed between two surfaces to fill and essentially seal the intervening space between the two surfaces, and may be subjected to compression between the two surfaces. Dynamic seals are typically disposed between a movable surface and a non-movable surface or another movable surface.

The application in which a seal is used affects the material properties of the seal, as well as its physical design. For example, seals may be subject to a wide variety of challenging environmental conditions, including exposure to high temperature, contact with corrosive chemicals, and high wear conditions during normal use. Dynamic seals, such as rotational seals or sleeves used between two rotating parts, may be subjected to appreciable friction or attendant heat either transmitted to or absorbed by the seal. In particular, rotational seals, between structures that have rotational movement, such as axles and other rotating shafts in engines and vehicular applications, may be subject to physical and environmental requirements and conditions, including the ability to function at elevated temperatures for extended periods of time and to withstand exposure to solvents or corrosive liquids or materials, while allowing movement of adjoining parts with minimal friction and containment of oil or other lubricating materials.

In some applications, rotational seals are coated with an external lubricant, so as to reduce friction and associated wear on adjoining parts and the seal. However, such lubricants can add to the cost and complexity of manufacturing structures containing such seals. Further, such lubricants can serve to electrically insulate the structures, which may be disadvantageous in applications where static electricity or other electrical potential should be dissipated.

### SUMMARY

The present technology provides elastomeric compositions, and associated methods of manufacturing, seals using such compositions, and methods of use, comprising an elastomeric material and lubricant material. In various embodiments, the elastomeric material comprises an FKM or HNBR elastomer. Compositions may further comprise a conductive filler material.

In various embodiments, elastomeric compositions comprise (a) an elastomeric material selected from the group consisting of FKM elastomers, HNBR elastomers, and blends thereof; and (b) a lubricant selected from the group consisting of methyl hydroxy stearate, hydroxystearamide, and mixtures thereof. For example, the FKM elastomer is derived from vinylidene fluoride, hexafluoropropylene, and tetrafluoroethylene. In some embodiments, the compositions further comprise a conductive filler, such as conductive carbon black.

The present technology also provides cassette seals comprising an elastomeric seal composition of the present technology. Also provided are sleeve seals comprising an elastomeric seal composition of the present technology.

### DRAWINGS

The drawings described in this disclosure depict non-limiting exemplary embodiments of seals that may be made using the compositions of the present technology. In particular:

FIG. 1 depicts an exemplary flanged cassette seal of the present technology;

FIG. 2 depicts an exemplary non-flanged sleeve seal of the present technology;

FIG. 3 depicts an exemplary L-case single element seal of the present technology;

FIG. 4 depicts another exemplary L-case single element seal of the present technology;

FIG. 5 depicts another exemplary L-case single element seal of the present technology; and

FIG. 6 depicts a flanged single element seal of the present technology;

It should be noted that the figures are intended to exemplify the general characteristics of apparatus and materials among those of this invention. The figures may not precisely reflect the characteristics of any given embodiment and are not necessarily intended to define or limit specific embodiments within the scope of the subject technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

### Compositions

The present technology provides compositions comprising an elastomeric material and a lubricating additive, operable for use as a seal, sleeve or other elastomeric member in contact with two or more parts having rotational or other relative translational movement.

### Elastomeric Material

The compositions of the present technology comprise one or more elastomeric materials, i.e., rubber-like polymeric solids having elastic properties. In various embodiments, the elastomeric material comprises a fluoroelastomer, a nitrile rubber (HNBR), and blends thereof. Fluoroelastomers may include FKM elastomers (fluorine kautschuk material), that utilize vinylidene fluoride (VDF) as a co-monomer. In some embodiments, the fluoroelastomer may be a perfluoroelastomer (FFKM), such as a tetrafluoroethylene propylene elastomer (FEPM).

In various aspects, such FKM elastomers meet the criteria of ASTM D1566, i.e. the material will retract to less than 1.5 times its original length within one minute after being stretched at room temperature to twice its original length and held for one minute before release, ASTM D412 (tensile set parameters), and ASTM D395 (elastic requirements for compression set). In various embodiments, FKM elastomers comprise commercially available copolymers of one or more fluorine containing monomers in addition to VDF, chiefly hexafluoropropylene (HFP), tetrafluoroethylene (TFE), and perfluorovinyl ethers (PFVE). Such PFVE monomers include those with a C₁₋₈ perfluoroalkyl group, preferably perfluoroalkyl groups with 1 to 6 carbons, and particularly perfluoromethyl vinyl ether and perfluoropropyl vinyl ether. In addition, the copolymers may also contain repeating units derived from olefins such as ethylene and propylene. In general, there are five types of FKM elastomers:
Type 1—comprising VDF and hexafluoroprene (HFP);
Type 2—comprising VDF, HFP and tetrafluoroethylene (TFE);
Type 3—comprising VDF, TFE and perfluoromethylvinylether (PMVE);
Type 4—comprising VDF, TFE and propylene; and
Type 5—comprising VDF, HFP, TE, PMVE and ethylene.

See D. Hertz, Jr, “Fluoroelastomers,” in K. C. Baranwal & H. L. Stephens (eds.), Basic Elastomer Technology, Chapt. 11.D. (ACS 2001); and D. Hertz, Jr., Fluorine-Containing Elastomers (Seals Eastern, Inc.) (available on the World Wide Web at sealseastern.com/PDF/FluoroAcsChapter.pdf). In various embodiments, the present compositions comprise a Type 2 FKM, i.e., comprising VDF, HFP and TFE. In various embodiments, the fluorine content of the FKM is from about 50% to about 75%. In various embodiments, such polymers contain about or more than 66, 67, 68, 69, 70, 71, or 72 mol. %, and up to or about 75 mol. % fluorine.

In some embodiments, elastomeric compositions comprise a VDF/HFP/TFE elastomer having a Mooney viscosity from about 25 to about 75, fluorine at from about 65 to about 69 atomic weight percent, and at least 90 weight percent fluoroterpolymer, and halogenated crosslink sites. Such FKMs are commercially available from Chemours Company (formerly E. I. du Pont de Nemours & Co.) under the tradename Viton. FKMs useful herein are also commercially available from Elastomer suppliers including Dyneon (3M), Asahi Glass Fluoropolymers, Solvay/Ausimont, and Daikin.

In general, the FKM can be cured by diamine crosslinking, ionic crosslinking or peroxide crosslinking. The composition also comprises a curing agent at a concentration from about 0.5 to about 20 parts per 100 parts by weight of the fluoroelastomer particulate. In this regard, the curing agent accelerates crosslinking of the fluoroelastomer as the admixture cures to provide a continuous elastomer phase and also to release hydrogen ions into the curing admixture.

For example, cross-linking reactions of cure-site monomer residues can be initiated by contact under elevated temperature with a curing agent, such as any of the organic peroxide, aliphatic polyol (e.g., diol), aromatic polyol (e.g., polyphenol, such as bisphenol), or polyamine (e.g., diamine) curing agents known in the art, or a combination thereof. A curing system can utilize an organometallic curing agent or an onium salt, e.g., an aliphatic or aromatic ternary phosphonium or sulfonium halide or quaternary ammonium halide, which can be used, e.g., with a phenolic curing agent.

In various embodiments, elastomeric compositions of the present technology comprise a nitrile rubber derived from acrylonitrile and butadiene. Such nitrile rubbers include butyl rubber elastomer (NRB) and hydrogenated nitrile butyl rubber elastomer (HNBR). In various aspects of the present technology, elastomeric compositions comprise HNBR. HNBR elastomers among those useful herein are commercially available from a variety of sources, including Lianda Corporation, Arlanxeo, and Zeon Chemical. In some embodiments, HNBR elastomers comprise a medium range content of acrylonitrile, and are fully hydrogenated. Such HNBRs can be peroxide cured.

### Lubricating Additive

The elastomeric compositions of the present technology further comprise a lubricating material. In various embodiments, the lubricating material is selected from the group consisting of methyl hydroxy stearate (methyl 12-hydroxy stearate), hydroxystearamide (12-hydroxystearamide), and mixtures thereof. In some embodiments, the lubricating material consists of, or consists essentially of, methyl hydroxy stearate.

### Conductive Particles

In some embodiments, the elastomeric compositions of the present technology comprise a conductive material, such as a conductive particulate. In various aspects, elastomeric compositions comprise a dispersed phase of conductive particulate so that the composition has a post-cured electrical resistivity of less than about of 1×10⁻³ Ohm-m at 20° C. In various embodiments, the resistance across the seal (from the shaft to the bore of a radial seal) is less than about 1000 ohms, or about 500 ohms or less, or about 100 ohms or less.

Conductive particles useful herein may include conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof. In another aspect, filler is mixed into the composition, with the filler being any of fiberglass particulate, inorganic fiber particulate, carbon fiber particulate, ground rubber particulate, polytetrafluorinated ethylene particulate, microspheres, and carbon nanotubes. In some embodiments, elastomeric compositions comprise carbon black, which may have a bulk density of from about 90 to about 90 kg/m³ to about 100 kg/m³ and an average particle size of from about 40 nm to about 60 nm, or about 50 nm.

### Optional Materials

The elastomeric compositions of the present technology may optionally comprise additives such as stabilizers, processing aids, curing accelerators, fillers, pigments, adhesives, tackifiers, and waxes. For example, fillers may include inert particulates such as calcium carbonate, barium sulfate, zinc sulfide, carbon black (e.g., SAF black, HAF black, SRP black and Austin black), titanium dioxide, clay, talc, fiber glass, ground rubber particulate, silica, fumed silica, ceramic and glass microspheres, graphite, kaolin, ground rubber particulate, polytetrafluorinated ethylene particulate, and discontinuous fibers such as mineral fibers, wood cellulose fibers, carbon fiber, boron fiber, and aramid fiber (Kevlar), and combinations thereof.

Compositions may comprise processing aids, such as plasticizers and mold release agents. Examples of processing aids include carnauba wax, phthalate ester plasticizers such as dioctylphthalate (DOP) and dibutylphthalate silicate (DBS), fatty acid salts such zinc stearate and sodium stearate, polyethylene wax, and keramide.

Compositions may comprise acid acceptor compounds as curing accelerators or curing stabilizers. In various embodiments, acid acceptor compounds include oxides and hydroxides of divalent metals, such as Ca(OH)₂, MgO, CaO, and ZnO.

Elastomeric compositions may also comprise wax particulates, such as to improve flow properties. Examples of wax particulate include paraffin, carnauba wax, polypropylene wax and combinations thereof.

### Formulations

In various embodiments, the present invention provides a gasket composition comprising:

| | Content (by weight of |
|---|---|
| Material | composition, all approximate) |
| Elastomer | 30%-85% |
| (FKM or HNBR) | 40%-80% |
| | 45%-75% |
| Cure Agent (e.g., | 0.5%-6% |
| peroxide, bisphenol) | 0.8%-5% |
| | 1%-4.5% |
| Lubricant | 0.5%-5% |
| | 1%-3% |
| | 1.5%-2.5% |
| Conductive Filler (e.g., | 0%-45% |
| conductive carbon black) | 10%-35% |
| | 12%-35% |
| Non-conductive filler (e.g., | 0%-45% |
| non-conductive carbon black) | 15%-40% |
| | 20%-35% |
| Cure Accelerator | 0%-3% |
| (e.g., MgO) | 1%-2% |
| Activator | 0%-1% |
| (e.g., stearic acid) | 0.5%-0.8% |

In some embodiments, compositions comprise from about 40% to about 85%, or from about 45% to about 65% of FKM, such as a peroxide-cure FKM or bisphenol-cure FKM. In some embodiments, compositions comprise from about 40% to about 60%, or from about 45% to about 55% of HNBR.

In some embodiments in end-use applications for electrically-conductive seals or other components, compositions may comprise 70% to about 80% of a peroxide-cured FKM and about 10% to about 20% of a conductive filler. In other embodiments, such compositions may comprise from about 45% to about 55% of HNBR and from about 25% to about 35% of a conductive filler.

### Manufacturing Processes

Methods for making the compositions and seal structures of the present technology include those known in the art. In general, compositions may be manufactured by conventional admixing the elastomeric components, lubricant and (if present) conductive filler, and milling the blended material.

### Seal Structures

The present technology provides seal structures and other products comprising elastomeric compositions, including such compositions as described above. As referred to here, such “seal structures” include any seal, gasket, sleeve or other elastomeric structure that provides an interface between two more structures. Such seals may be static or dynamic. In various embodiments, dynamic seals are rotational seals, disposed between two or more structures that exhibit relative rotation. Such rotational seals of the present technology may be used in a variety of applications, such as in engines and drive train parts and assemblies in automotive, truck, aerospace and other vehicles.

In various aspects, without limiting the scope or function of the present technology, the lubricating materials in the seals of the present technology diffuse or otherwise migrate to the surface of the seals in use, thus obviating the need for application of an external lubricant. Accordingly, in various embodiments, the present technology provides self-lubricating seals, such that no or low levels of lubricant are applied to the surface of the seals during manufacturing or use.

In various aspects, without limiting the scope or function of the present technology, as discussed above, elastomeric seal compositions comprising a conductive filler material have reduced electrical resistance relative to seals among those known in the art. Such conductive seals may dissipate or otherwise conduct electrical charges, such as may occur due to varying electrical potentials between structures disposed in contact with the seals, or static electricity produced during rotational or other movement of such structures. Such conductive seals may provide benefits in e-mobility applications where seals may allow dissipation of electrical charges that are imparted to structures (e.g., drive shafts) by operation of electric motors or other devices.

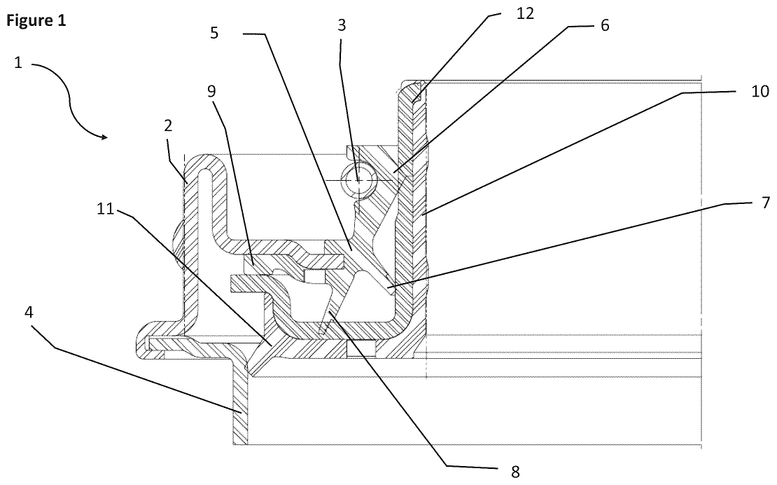

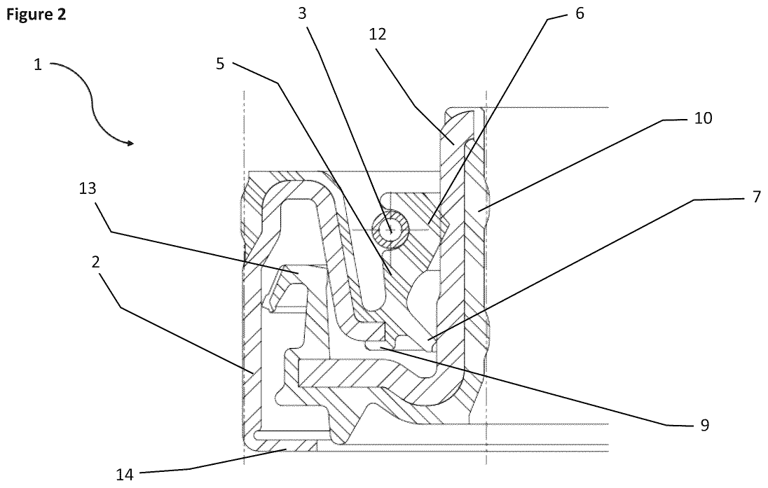

Exemplary cassette seals of the present technology are depicted in FIGS. 1 and 2, comprising an elastomeric composition as described above. Such cassette seals (1) may be flanged, as shown in FIG. 1, or non-flanged, as shown in FIG. 2. Such cassette seals may be used in a variety of applications, including in environments where seals may be exposed to contaminants such as dust or water (e.g., output seals, wheel end seals, and hub seals). In other aspects, such seals may be used for blind installations (i.e., where the seal is not readily accessible), such as axle tube seals.

With reference to FIGS. 1 and 2, an exemplary cassette seal structure (1) may include metal case (2) and spring (3). First seal (5) comprises main seal lip (6), dust lip (7), and bumper stop (9). Second seal (10) comprises radial exclusion lip (11). Sleeve (12) is disposed between the first seal (5) and the second seal (10). In various aspects the second seal (10) is formed from an elastomeric composition of the present technology which comprises a lubricant, conductive material, or mixture thereof. Further, as shown in the cassette seal of FIG. 1, metal case (2) may include unitizing ring (4), and the first seal (5) may include an axial excluder lip (8). Also, as shown in the cassette seal of FIG. 2, metal case (2) may include a retaining curl (14), and the second seal (10) may include hook lip excluder (13).

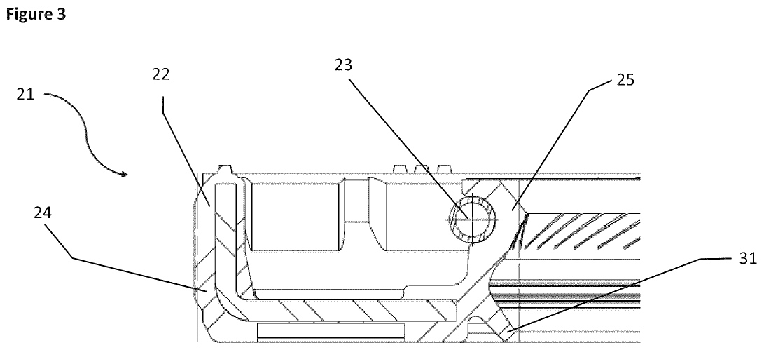

Exemplary sleeve seals of the present technology are depicted in FIGS. 3, 4, 5 and 6, comprising an elastomeric composition as described above. Such sleeve seals may be used in a variety of applications, including as described above. In various aspects, the seal composition of the present technology is in a sleeve, which provides a running surface for a sprung lip seal component and the static seal between the running surface and a shaft. Lubrication may be desired at the sleeve where the shaft is manually pressed through the sleeve inner diameter to create a static seal.

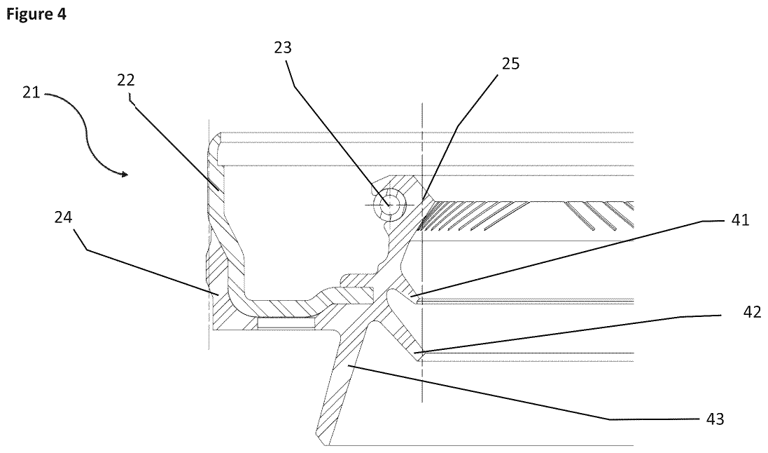

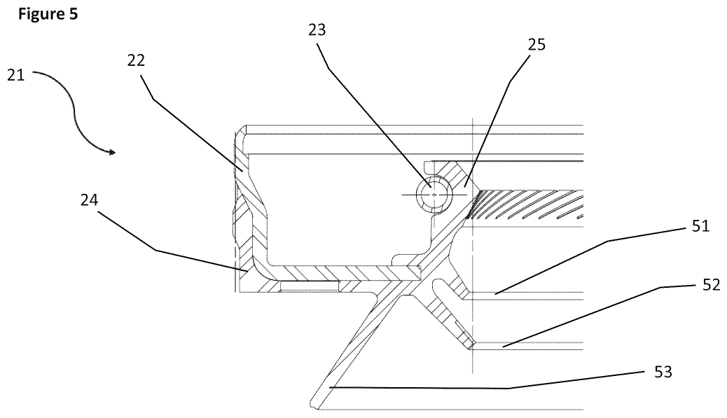

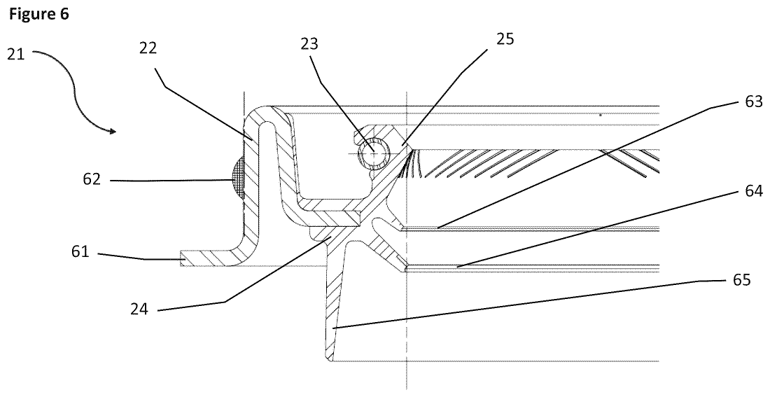

With reference to FIGS. 3, 4, 5, and 6, single element seal structures (22) may include a metal case (22) and spring (23). Seal (24) comprises main seal lip (25). In various aspects the seal (24) is formed from an elastomeric composition of the present technology which comprises a lubricant, conductive material, or mixture thereof. Seal (24) may include additional lip structures. For example, as shown in FIG. 3, seal (24) may include dust lip (31). As shown in FIG. 4, seal (24) may include clearance dust lip (41), contacting dust lip (42), and radial excluder lip (43). As shown in FIG. 5, seal (24) may include non-contacting dust lip (51), non-contacting dust lip (52) and contacting axial lip (53). As shown in FIG. 6, a flanged seal (21) further includes flange/install stop (61), outer sealant (62), clearance non-contacting dust lip (63), contacting dust lip (64), and non-contacting axial lip (65).

Exemplary elastomeric materials, manufacturing processes, and structures among those useful herein are described in the following patent disclosures, incorporated by reference herein: U.S. Pat. No. 7,022,769, Park, issued Apr. 4, 2006; U.S. Pat. No. 7,718,736, Park et al., issued May 18, 2010; and U.S. Patent Application Publication 2007/0044906, Park, published Mar. 1, 2007.

### Non-Limiting Listing of Exemplary Embodiments

The present technology includes the following exemplary embodiments.

### Embodiment A1

An elastomeric seal composition comprising:
(a) an elastomeric material selected from the group consisting of FKM elastomers, HNBR elastomers, and blends thereof; and
(b) a lubricant selected from the group consisting of methyl hydroxy stearate, hydroxystearamide, and mixtures thereof.

### Embodiment A2

The elastomeric seal composition of Embodiment A1, wherein the elastomeric material comprises an FKM elastomer.

### Embodiment A3

The elastomeric seal composition of Embodiment A2, wherein the FKM elastomer is derived from vinylidene fluoride, hexafluoropropylene, and tetrafluoroethylene.

### Embodiment A4

The elastomeric seal composition of Embodiment A2 or Embodiment A3, comprising from about 45% to about 65% of the FKM elastomer.

### Embodiment A5

The elastomeric seal composition of Embodiment A1, wherein the elastomeric material comprises an HNBR.

### Embodiment A6

The elastomeric seal composition of Embodiment A5, comprising from about 45% to about 55% of the HNBR.

### Embodiment A7

The elastomeric seal composition of any one of the preceding Embodiments, wherein the lubricant material comprises methyl hydroxy stearate.

### Embodiment A8

The elastomeric seal composition of any one of the preceding Embodiments, further comprising a conductive filler.

### Embodiment A9

The elastomeric seal composition of Embodiment A8, wherein the conductive filler comprises conductive carbon black.

### Embodiment A10

The elastomeric seal composition of Embodiment A9, comprising from about 12% to about 35% of the carbon black.

### Embodiment A11

The elastomeric seal composition of any one of the preceding Embodiments, further comprising a non-conductive filler.

### Embodiment A12

The elastomeric seal composition of Embodiment A10, wherein the non-conductive filler comprises carbon black.

### Embodiment A13

The elastomeric seal composition of Embodiment A11 or A12, comprising from about 20% to about 35% of the non-conductive filler.

### Embodiment A14

A cassette seal comprising the elastomeric seal composition of any one of the preceding Embodiments.

### Embodiment A15

A sleeve seal comprising the elastomeric seal composition of any one of Embodiments A1-A13.

### Embodiment B1

A self-lubricating seal comprising:
(a) from about 50% to about 65% of an FKM elastomer; and
(b) from about 1% to about 2% of a lubricant material selected from the group consisting of methyl hydroxy stearate, hydroxystearamide, and mixtures thereof.

### Embodiment B2

The self-lubricating seal of Claim B1, wherein the FKM elastomer is derived from vinylidene fluoride, hexafluoropropylene, and tetrafluoroethylene.

### Embodiment B3

The self-lubricating seal composition of Embodiment B1 or Embodiment B2, wherein the lubricant material comprises methyl hydroxy stearate.

### Embodiment C1

A self-lubricating seal comprising:
(a) from about 40% to about 55% of an HNBR; and
(b) from about 1% to about 3% of a lubricant material selected from the group consisting of methyl hydroxy stearate, hydroxystearamide, and mixtures thereof.

### Embodiment C2

The self-lubricating seal composition of Embodiment C1, wherein the lubricant material comprises methyl hydroxy stearate.

### Embodiment D1

A conductive seal comprising:
(a) from about 50% to about 65% of an FKM; and
(b) from about 1% to about 2% of a lubricant material selected from the group consisting of methyl hydroxy stearate, hydroxystearamide, and mixtures thereof; and
(c) from about 10% to about 20% of a conductive filler.

### Embodiment D2

The conductive seal of Embodiment D1, wherein the FKM elastomer is derived from vinylidene fluoride, hexafluoropropylene, and tetrafluoroethylene.

### Embodiment D3

The conductive seal composition of Embodiment D1 or Embodiment D2, wherein the lubricant material comprises methyl hydroxy stearate.

### Embodiment D4

The conductive seal composition of any one of Embodiments D1-D3, wherein the conductive filler comprises conductive carbon black.

### Embodiment E2

A conductive seal comprising:
(a) from about 45% to about 55% of an HNBR; and
(b) from about 1% to about 3% of a lubricant material selected from the group consisting of methyl hydroxy stearate, hydroxystearamide, and mixtures thereof; and
(c) from about 25% to about 35% of a conductive filler.

### Embodiment E2

The conductive seal composition of Embodiment E1, wherein the lubricant material comprises methyl hydroxy stearate.

### Embodiment E3

The conductive seal composition of Embodiment E1 or Embodiment E2, wherein the conductive filler comprises conductive carbon black.

### Non-limiting Discussion of Terminology

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The description and specific examples, while indicating embodiments of the technology, are intended for purposes of illustration only and are not intended to limit the scope of the technology. Equivalent changes, modifications and variations of specific embodiments, materials, compositions and methods may be made within the scope of the present technology, with substantially similar results. Moreover, recitation of multiple embodiments having stated features is not intended to exclude other embodiments having additional features, or other embodiments incorporating different combinations of the stated features. For example, a component which may be A, B, C, D or E, or combinations thereof, may also be defined, in some embodiments, to be A, B, C, or combinations thereof. Specific examples are provided for illustrative purposes of how to make and use the compositions and methods of this technology and, unless explicitly stated otherwise, are not intended to be a representation that given embodiments of this technology have, or have not, been made or tested.

As used herein, the words “prefer” or “preferable” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein. Further, as used herein the term “consisting essentially of” recited materials or components envisions embodiments “consisting of” the recited materials or components.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

Unless otherwise stated herein, or evident in context, all percentages are by weight of composition.

As referred to herein, ranges are, unless specified otherwise, inclusive of endpoints and include disclosure of all distinct values and further divided ranges within the entire range. Thus, for example, a range of “from A to B” or “from about A to about B” is inclusive of A and of B. Further, the phrase “from about A to about B” includes variations in the values of A and B, which may be slightly less than A and slightly greater than B; the phrase may be read be “about A, from A to B, and about B.” The phase “less than about x” means about X or less than X. Similarly, the phrase “greater than about X” means about X or greater than X. Disclosure of values and ranges of values for specific parameters (such as temperatures, molecular weights, weight percentages, etc.) are not exclusive of other values and ranges of values useful herein.

It is also envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. An elastomeric seal composition comprising:
(a) an elastomeric material selected from the group consisting of FKM elastomers, HNBR elastomers, and blends thereof, and
(b) a lubricant selected from the group consisting of methyl hydroxy stearate, hydroxystearamide, and mixtures thereof.

2. The elastomeric seal composition of claim 1, wherein the elastomeric material comprises an FKM elastomer derived from vinylidene fluoride, hexafluoropropylene, and tetrafluoroethylene.

3. The elastomeric seal composition of claim 2, comprising from about 45% to about 65% of the FKM elastomer.

4. The elastomeric seal composition of claim 1, wherein the elastomeric material comprises an HNBR.

5. The elastomeric seal composition of claim 4, comprising from about 45% to about 55% of the HNBR.

6. The elastomeric seal composition of claim 1, wherein the lubricant material comprises methyl hydroxy stearate.

7. The elastomeric seal composition of claim 1, further comprising a conductive filler.

8. The elastomeric seal composition of claim 7, wherein the conductive filler comprises conductive carbon black.

9. The elastomeric seal composition of claim 1, further comprising a non-conductive filler.

10. A cassette seal comprising the elastomeric seal composition of claim 1.

11. A sleeve seal comprising the elastomeric seal composition of claim 1.

12. A self-lubricating seal comprising:
(a) from about 50% to about 65% of an FKM elastomer; and
(b) from about 1% to about 2% of a lubricant material selected from the group consisting of methyl hydroxy stearate, hydroxystearamide, and mixtures thereof.

13. The self-lubricating seal of claim 12, wherein the FKM elastomer is derived from vinylidene fluoride, hexafluoropropylene, and tetrafluoroethylene.

14. The self-lubricating seal composition of claim 12, wherein the lubricant material comprises methyl hydroxy stearate.

15. A self-lubricating seal comprising:
(a) from about 40% to about 55% of an HNBR; and
(b) from about 1% to about 3% of a lubricant material selected from the group consisting of methyl hydroxy stearate, hydroxystearamide, and mixtures thereof.

16. A conductive seal comprising:
(a) from about 50% to about 65% of an FKM; and
(b) from about 1% to about 2% of a lubricant material selected from the group consisting of methyl hydroxy stearate, hydroxystearamide, and mixtures thereof; and
(c) from about 10% to about 20% of a conductive filler.

17. The conductive seal of claim 16, wherein the FKM elastomer is derived from vinylidene fluoride, hexafluoropropylene, and tetrafluoroethylene.

18. The conductive seal composition of claim 16, wherein the conductive filler comprises conductive carbon black.

19. A conductive seal comprising:
(a) from about 45% to about 55% of an HNBR; and
(b) from about 1% to about 3% of a lubricant material selected from the group consisting of methyl hydroxy stearate, hydroxystearamide, and mixtures thereof; and
(c) from about 25% to about 35% of a conductive filler.

20. The conductive seal composition of claim 19, wherein the conductive filler comprises conductive carbon black.
